(19) United States
(12) Patent Application Publication
(10) Pub. No.: US 2025/0168259 A1
(43) Pub. Date: May 22, 2025

(54) IN-VEHICLE COMMUNICATION DEVICE

(71) Applicant: HITACHI ASTEMO, LTD., Hitachinaka-shi, Ibaraki (JP)

(72) Inventors: Ryo FUKUDA, Chiyoda-ku, Tokyo (JP); Kazuhiro NAKANISHI, Chiyoda-ku, Tokyo (JP); Masaaki NAKAMURA, Chiyoda-ku, Tokyo (JP)

(73) Assignee: HITACHI ASTEMO, LTD., Hitachinaka-shi, Ibaraki (JP)

(21) Appl. No.: 18/841,470

(22) PCT Filed: Mar. 10, 2023
(86) PCT No.: PCT/JP2023/009291

§ 371 Date: Aug. 26, 2024

(30) Foreign Application Priority Data
Jun. 9, 2022 (JP) 2022-093722

(51) Int. Cl. H04L 69/18; H04L 12/40; H04W 4/40

(52) U.S. Cl. CPC H04L 69/18; H04L 12/40; H04L 2012/40215; H04W 4/40

(57) ABSTRACT

An in-vehicle communication device according to an embodiment of the present invention is an in-vehicle communication device connected to a first network that performs communication using a first frame generated according to a first communication protocol and a second network that performs communication using a second frame generated according to a second communication protocol, the in-vehicle communication device includes a transmission and reception unit that transmits and receives the first frame and the second frame, in which, when receiving a transfer request of a plurality of first frames from the second network, the transmission and reception unit transmits the second frame storing the plurality of first frames to the second network in response to the transfer request.

### TECHNICAL FIELD

The present invention relates to a communication device mounted on a vehicle, and particularly relates to an in-vehicle communication device that performs transfer control of data between different communication paths.

### BACKGROUND ART

In recent years, with the promotion of connected vehicles, there have been increasing cases where a vehicle and a vehicle outside server communicate with each other, for example, an external server accumulates and manages vehicle information. At this time, data of the ECU connected to another communication bus different from the communication bus to which a communication control unit (TCU) or the like is connected is transferred to the bus to which the TCU is connected by a communication device such as a gateway that relays communication. A transfer rule of which data is to be transferred to the bus of the TCU, which is referred to during transfer, is operated according to a transfer table recorded in a storage medium in the vehicle during vehicle production. For this reason, when a change in data to be accumulated exists, rewrite of the transfer table is required. For rewrite of these data, a vehicle is brought to a dealer or the like to update software, and in recent years, there is an update method using a remote software update technology (OTA: Over The Air) as in PTL 1.

### CITATION LIST

### Patent Literature

PTL 1: JP 2021-128362A

### SUMMARY OF INVENTION

### Technical Problem

In PTL 1, a vehicle software update is basically performed while the vehicle is stopped such that vehicle control is not affected while the vehicle is traveling as the condition starting the software update is “when ignition is off”. For this reason, data accumulated by the server cannot be changed in real time depending on a vehicle state, a traveling status, and the like during traveling of the vehicle.

The present invention has been made in view of the above problems, and an object of the present invention is to provide an in-vehicle communication device that enables the data transfer without stopping the vehicle when receiving an instruction to change transfer data from the server while the vehicle is traveling.

### Solution to Problem

In order to solve the problem, an in-vehicle communication device according to an embodiment of the present invention is an in-vehicle communication device connected to a first network that performs communication using a first frame generated according to a first communication protocol and a second network that performs communication using a second frame generated according to a second communication protocol. The in-vehicle communication device includes a transmission and reception unit that transmits and receives the first frame and the second frame. When receiving a transfer request of a plurality of first frames from the second network, the transmission and reception unit transmits the second frame storing the plurality of first frames to the second network in response to the transfer request.

### Advantageous Effects of Invention

According to the present invention, when the instruction to change the transfer data is received from the server while the vehicle is traveling, the data can be transferred without stopping the vehicle.

Problems, configurations, and effects other than those described above will be clarified by the following description of embodiments.

### BRIEF DESCRIPTION OF DRAWINGS

FIG. 1 is a block diagram illustrating a configuration of an in-vehicle communication device according to a first embodiment.

FIG. 2 is a view illustrating an example of a transfer table before a change instruction frame is received.

FIG. 3 is a view illustrating an example of the transfer table after the change instruction frame is received and updated.

FIG. 4 is a view illustrating an example of a configuration of the change instruction frame.

FIG. 5 is a view illustrating an example of a configuration of the transfer frame when a plurality of communication frames are packed.

FIG. 6 is a flowchart illustrating processing executed by the in-vehicle communication device according to the first embodiment.

FIG. 7 is a flowchart illustrating processing executed by a T-ECU.

FIG. 8 is a block diagram illustrating a configuration of an in-vehicle communication device according to a second embodiment.

FIG. 9 is a flowchart illustrating processing executed by the in-vehicle communication device according to the second embodiment.

### DESCRIPTION OF EMBODIMENTS

Hereinafter, embodiments will be described with reference to the drawings.

### First Embodiment

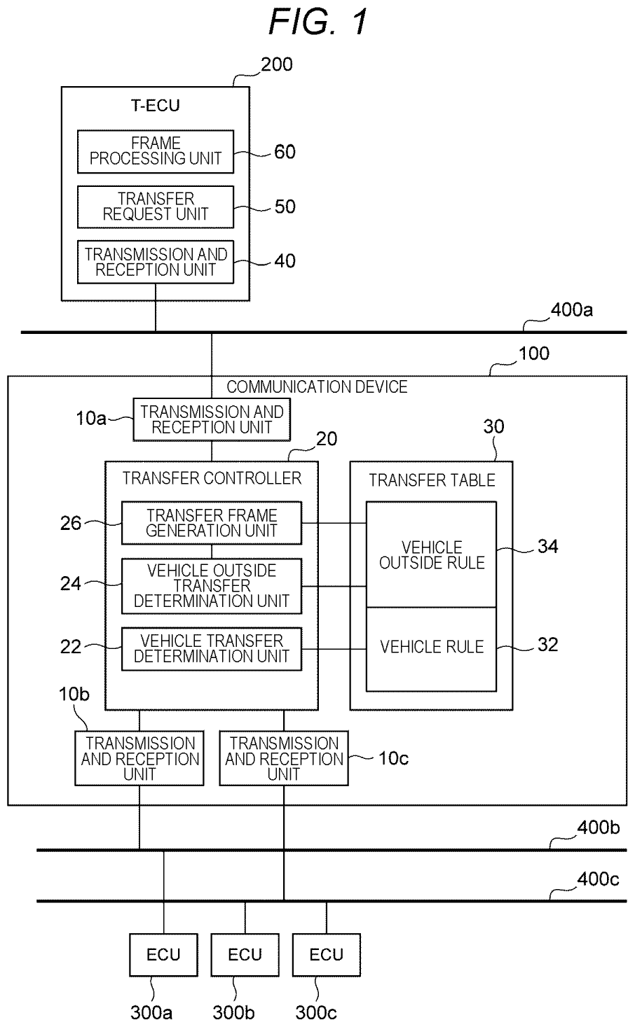

FIG. 1 is a functional block diagram illustrating a configuration of an in-vehicle communication device 100 (hereinafter, simply referred to as a communication device 100) according to a first embodiment of the present invention. The communication device 100 includes a known microcomputer including a memory and a CPU, and includes transmission and reception units 10a to 10c, a transfer controller 20, and a transfer table 30.

The communication device 100 is connected to an in-vehicle equipment telematics-electrical control unit (T-ECU) 200 through a communication path 400a. The communication device 100 is also connected to ECUs 300a, 300b, and 300c through communication paths 400b and 400c. The communication device 100 performs transfer control of data received from each ECU.

The communication paths 400b and 400c are communication paths using a first communication protocol used by the ECUs 300a, 300b, and 300c, and the communication path 400a is a communication path using a second communication protocol used by the T-ECU 200, the second communication protocol having a higher transmission speed than the first communication protocol. The communication device 100 internally performs protocol conversion for transfer between these two types of communication protocols, and changes and transfers a communication frame. A number of ECUs and a number of communication paths are not limited to the illustrated number, and can be arbitrarily adjusted. The communication device 100 may have a function of not only passively receiving data from each ECU but also spontaneously communicating with each ECU. In addition, the first and second communication protocols are not necessarily limited to different types of communication protocols, but the communication protocols used in the communication paths 400a, 400b, and 400c may be the same.

The T-ECU 200 is connected to an external server, and has a function of instructing the communication device 100 so as to change a transfer content of a data transfer performed from the communication device 100 to the T-ECU 200. The T-ECU 200 may transmit a change instruction in response to an external operation such as TCU or navigation, or may voluntarily transmit the change instruction according to a situation.

At this point, in the first embodiment, the T-ECU 200 is equipment that implements a function not directly related to internal control of the vehicle on which the communication device 100 is mounted, and the ECUs 300a, 300b, and 300c are equipment that implements a function directly related to the internal control of the vehicle.

The transmission and reception units 10a to 10c are known communication modules having a function of transmitting and receiving data to and from each ECU through each communication path. In FIG. 1, for convenience of description, one transmission and reception unit corresponds to one communication path in the transmission and reception units 10a to 10c, but one transmission and reception unit may correspond to a plurality of communication paths.

The transfer table 30 records a transfer rule of data received by the communication device 100 from the T-ECU 200 and the ECUs 300a, 300b, and 300c through the respective communication paths in a storage medium. In other words, for example, the transfer table is stored in a nonvolatile storage medium of the communication device 100. The transfer table is divided into a vehicle rule 32 indicating the transfer rule of data internally required for vehicle control and a vehicle outside rule 34 indicating the transfer rule of data that is transferred to the T-ECU 200 and is not related to the vehicle control. The transfer table 30 may be a simple table in which an identification mark associated with a signal (hereinafter, a communication frame) such as an ID and a transmission destination of each signal are described, or a rule for packing a plurality of communication frames into one communication frame may be described. In addition, the division of this rule is a pseudo rule for limiting modules that can be accessed by addresses, and may actually exist in a continuous address space on a memory.

The transfer controller 20 includes a vehicle transfer determination unit 22, a vehicle outside transfer determination unit 24, and a transfer frame generation unit 26, and controls a transfer function by the communication device 100. The vehicle transfer determination unit 22 can access only the vehicle rule 32, and the vehicle outside transfer determination unit 24 and the transfer frame generation unit 26 can access only the vehicle outside rule 34.

The vehicle transfer determination unit 22 refers to the vehicle rule 32 and determines whether the data received from the communication paths 400a, 400b, and 400c is required to be transferred to the communication paths 400b and 400c. That is, the transfer to the ECUs 300a, 300b, and 300c having a function of directly affecting the internal control of the vehicle is determined.

On the other hand, the vehicle outside transfer determination unit 24 refers to the vehicle outside rule 34, and determines whether the data received from the communication paths 400b and 400c is required to be transferred to the communication path 400a. In other words, the transfer to the T-ECU 200 having a function that does not directly affect the internal control of the vehicle is determined. Furthermore, when receiving a change instruction frame of the transfer content to the T-ECU 200 from the T-ECU 200, the vehicle outside transfer determination unit 24 updates the vehicle outside rule 34 according to the content of the change instruction frame. When the ID requested to be transferred is not a periodic transmission frame, vehicle the outside transfer determination unit 24 requests the transmission to the ECU that transmits a first communication frame of the ID. This is because of the following reasons.

For example, regarding the number of torques of an engine, values of various sensors, and the like, the data is periodically (for example, a cycle of 10 ms or 100 ms) transferred from each ECU. Accordingly, the data can be automatically received without the instruction to transmit the data from the side of the communication device 100. However, in the case of the ECU that does not periodically transmit the data as described above, this is because the data is not transmitted but the data required for the transfer cannot be obtained unless the instruction to transmit the data is given from the side of the communication device 100. Examples of the ECU that does not periodically transmit the data include the ECU related to diagnosis and the ECU related to the vehicle control but is not always required to transmit the latest data.

The transfer frame generation unit 26 refers to the vehicle outside rule 34 to generate a transfer frame to be transmitted to the communication path 400a. At this time, when the first communication protocol and the second communication protocol use different protocols, the first communication frame obeying the first communication protocol is converted into a second communication frame obeying the second communication protocol. In addition, when a packing rule is described in the vehicle outside rule 34, the transfer frame in which a plurality of first communication frames of a transfer target are integrated into one second communication frame is generated and transmitted to the communication path 400a. The transfer frame may be transferred periodically or aperiodically.

As described above, the vehicle outside rule 34 is a target of two pieces of processing of update processing performed by the vehicle outside transfer determination unit 24 when the change instruction is received and reference processing performed by the transfer frame generation unit 26 when the transfer frame is generated. However, in the case where the update processing and the reference processing are performed at the same time, a write operation and a read operation of the data are attempted at the same time, and there is a possibility that a problem is generated in the operation of the communication device 100. Accordingly, the transfer controller 20 performs exclusive control on the two operations in order to prevent the update operation of the vehicle outside transfer determination unit 24 with respect to the vehicle outside rule 34 and the reference operation of the transfer frame generation unit 26 from generating at the same time and causing the problem. In the case where these operations are attempted at the same time, the update operation by the vehicle outside transfer determination unit 24 is prioritized.

As described above, the operation of the transfer controller 20 changes only the transfer rule to the outside of the vehicle that does not directly affect the vehicle control without changing the vehicle rule used for the data transfer of the vehicle control, so that the transfer change instruction from the outside of the vehicle can be responded to in real time. However, because the vehicle information is rewritten by receiving the instruction frame from the outside of the vehicle, there is a possibility that a malicious third party will permit malicious change to the vehicle information. For this reason, the transfer controller 20 may perform memory access control using a memory protection function (MPU) or the like in which a known microcomputer OS is mounted such that the vehicle rule 32 cannot be accessed in the change instruction frame from the outside of the vehicle. Furthermore, the change instruction from a communication partner other than a reliable communication partner may not be accepted by applying an electronic signature or encryption to the communication frame itself.

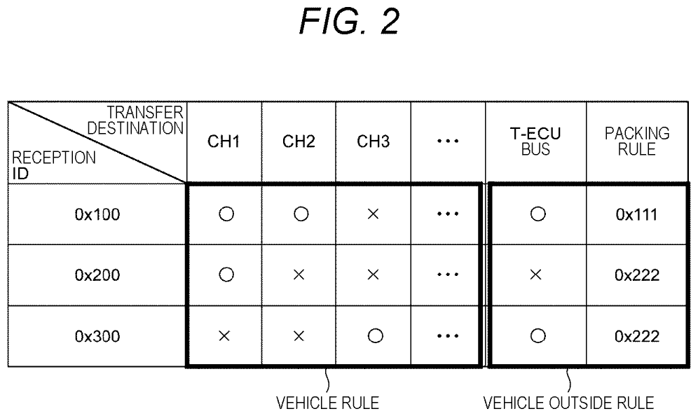

FIG. 2 is a view illustrating an example of the transfer table 30 in an initially set state, namely, before the change instruction frame is received. In the following description, it is assumed that a controller area network (CAN) is selected as the first communication protocol, and a CAN with flexible data rate (CAN FD) that handles a frame including a data portion larger than a data portion of a frame handled by the CAN is selected as the second communication protocol. The transfer table 30 describes transfer advisability of an ID (reception ID) of the received frame to each channel (CH) when the communication device 100 receives the communication frame. Regarding the transfer destination described in FIG. 2, CH1, CH2, and CH3 are the communication paths to which the vehicle rule is applied, namely, for example, communication paths 400b and 400c in FIG. 1 used for the transmission and reception of the data directly affecting the vehicle control. A transfer destination T-ECU bus is a communication path connected to the equipment (T-ECU 200 in FIG. 1) connected to the external server, and transmits and receives the data that does not directly affect the vehicle control.

At this time, as illustrated in FIG. 2, the description portion of the transfer rule to a place other than the T-ECU bus is referred to as the vehicle rule 32, and the description portion of the transfer rule to the T-ECU bus is referred to as the vehicle outside rule 34. Regarding the packing rule of the vehicle outside rule 34, in the case where the reception ID can be transferred to the T-ECU bus and a plurality of frames can be packed in one frame, which ID of the frame to be packed and transferred is described. As described above, it is assumed that the vehicle rule 32 is referred only from the vehicle transfer determination unit 22, and is not updated from the vehicle outside transfer determination unit 24 by the transfer change instruction.

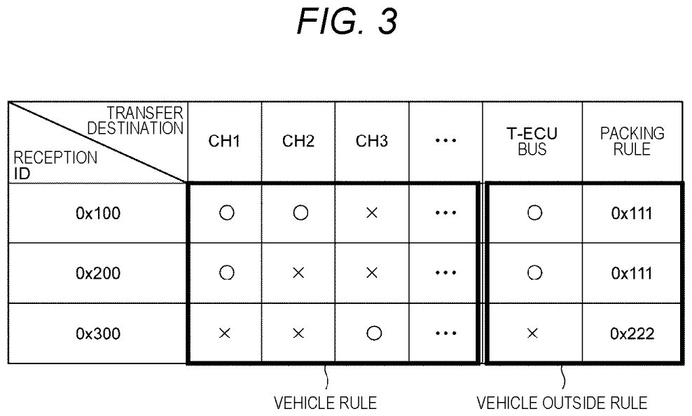

In FIG. 2, the communication frame to which the reception ID: 0x200 is assigned cannot be transferred to the T-ECU bus, and packing is performed on the frame with ID: 0x222 when the packing is performed. In addition, the communication frames to which reception IDs: 0x100 and 0x300 are assigned can be transferred to the T-ECU bus, and are packed in frames of IDs: 0x111 and 0x222, respectively. At this time, when receiving the change instruction frame of “the communication frame of reception ID: 0x 200 can be transferred to the T-ECU bus and packed at 0x111. The transfer of the communication frame of the reception ID: 0×300 is stopped.” from the T-ECU 200, the vehicle outside transfer determination unit 24 updates the vehicle outside rule 34 as illustrated in FIG. 3.

FIG. 3 is a view illustrating an example of the transfer table 30 after the communication device 100 receives and updated the change instruction frame. The change according to the instruction of the change instruction frame is made, and thereafter the vehicle outside transfer determination unit 24 and the transfer frame generation unit 26 execute the processing according to this table.

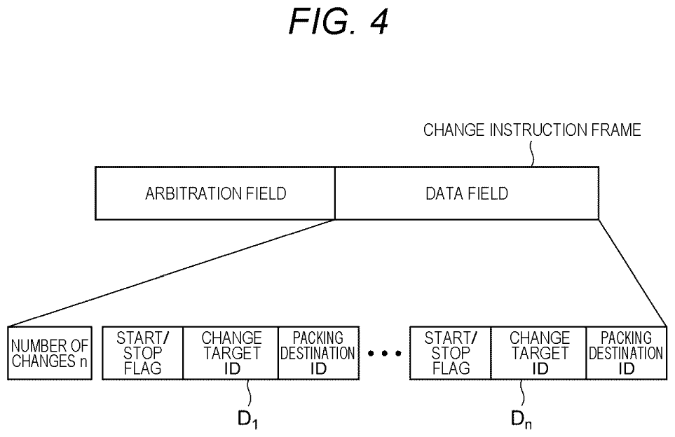

FIG. 4 is a view illustrating an example of the change instruction frame. The change instruction frame has a data structure according to CAN FD, and has an arbitration field used to identify data content and a transmission node and a data field in which the data is actually stored as a main region. The data field of the change instruction frame includes the number of transfer rules to be changed (n in FIG. 4) and connected data Dₖ including a start and stop flag, a change target ID, and a packing destination ID for each change.

The start and stop flag indicates the instruction to start or stop transfer for the change target ID to be described later. Specifically, for example, the start and stop flag has an identification flag in which a bit is set to 1 in the case of the start instruction and a bit is set to 0 in the case of the stop instruction. The change target ID specifies the transfer rule of the frame with which ID in the first communication frame is changed. The packing ID specifies the ID of the second communication frame to which the frame of the change target ID is packed and transferred. The ID actually used in the communication may be used as it is, or another identifier previously determined between the instruction side such as the server and the communication device 100 and corresponding to the actual ID may be used as the change target ID and the packing ID.

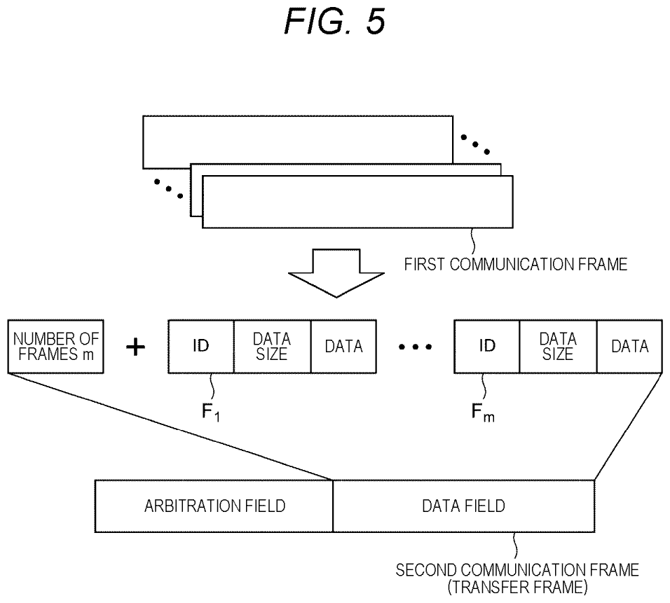

FIG. 5 is a view illustrating an example of a configuration of the transfer frame when a plurality of first communication frames are packed. A packing method in the case where the rule for packing a plurality of first communication frames is set for one second communication frame as the vehicle outside rule 34 will be described below.

First, the ID, the data size, and the data content of each frame are connected from the first communication frames having the ID designated by the change instruction frame illustrated in FIG. 4. The ID is acquired such that the reception side (in this case, the T-ECU 200 or the server) can understand which frame is accumulated and to what extent the data size is the data of the frame.

The ID used for the first communication frame may be assigned as it is, or another identifier that allows the reception side to understand the ID may be previously prepared and assigned. When all the pieces of data of the first communication frame to be packed are connected, the number of frames to which the frames are connected is assigned to the connected data (m in FIG. 5). The data obtained by connecting the data of the plurality of first communication frames is stored in the data field of the second communication frame to generate the transfer frame. In FIG. 5, the second communication frame has the configuration including the arbitration field and the data field. This is because the CAN FD is assumed as an example of the second protocol followed by the second communication frame. In the case where another protocol such as Ethernet (registered trademark) is used, the second communication frame is used in place of a corresponding concept such as a MAC address or a payload.

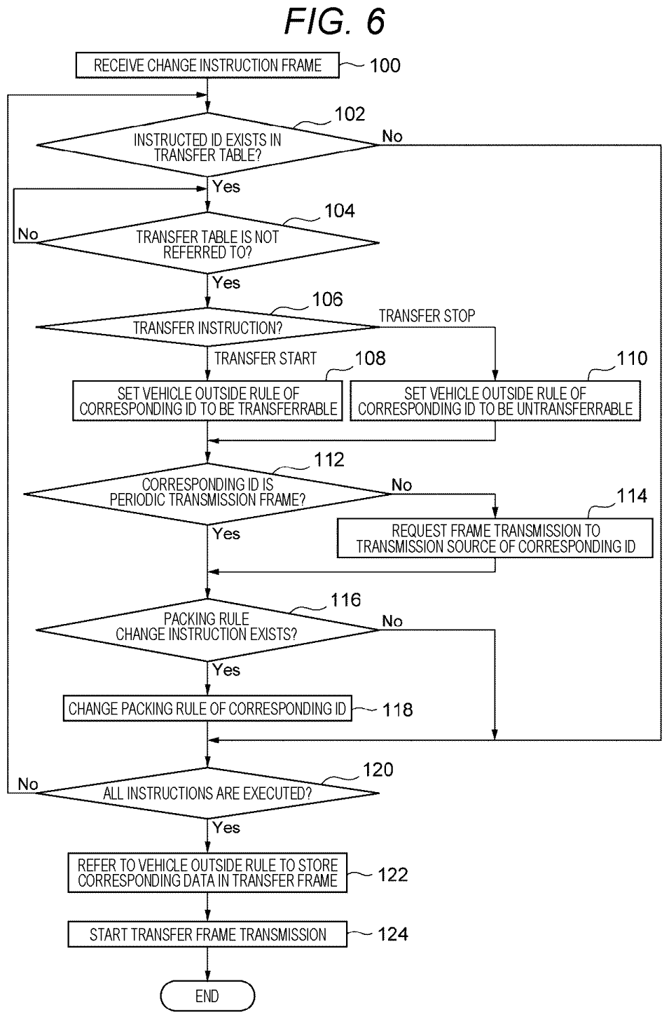

FIG. 6 is a flowchart illustrating processing executed by the in-vehicle communication device 100 according to the first embodiment.

First, in step 100, the transmission and reception unit 10a receives the change instruction frame from the T-ECU 200. In step 102, the vehicle outside transfer determination unit 24 checks whether the ID for which the change instruction is given exists in the transfer table 30. When the ID exists in the transfer table 30, the processing proceeds to step 104. When the ID does not exist in the transfer table 30, the processing proceeds to step 120.

In step 104, the vehicle outside transfer determination unit 24 checks whether the transfer frame generation unit 26 currently refers to the vehicle outside rule 34. The processing proceeds to step 106 when the reference is not currently made, and the processing waits until the reference is finished when the reference is currently made.

In step 106, the vehicle outside transfer determination unit 24 checks whether the change instruction is either the transfer start instruction or the transfer stop instruction. The processing proceeds to step 108 when the instruction is the transfer start instruction, and the processing proceeds to step 110 when the instruction is the transfer stop instruction.

In step 108, the vehicle outside transfer determination unit 24 sets the vehicle outside rule 34 of the corresponding ID to be transferable. In step 110, the vehicle outside rule 34 of the corresponding ID is set to be non-transferable.

In step 112, the vehicle outside transfer determination unit 24 checks whether the corresponding ID is the periodic transmission frame that is periodically transmitted. The processing proceeds to step 116 when the corresponding ID is the periodic transmission frame, and the processing proceeds to step 114 when the corresponding ID is not the periodic transmission frame.

In step 114, the vehicle outside transfer determination unit 24 transmits a frame transmission request of the ID to the transmission source ECU of the ID. The reason for this is as described above. In step 116, the vehicle outside transfer determination unit 24 checks whether a packing rule change instruction exists. The processing proceeds to step 118 when the change instruction exists, and the processing proceeds to step 120 when the change instruction does not exist.

In step 118, the vehicle outside transfer determination unit 24 changes the packing rule of the ID. In step 120, the vehicle outside transfer determination unit 24 checks whether all the change instructions in the change instruction frame are executed. The processing proceeds to step 122 when the processing is performed, and the processing proceeds to step 102 when the ID that is not changed yet.

In step 122, the transfer frame generation unit 26 refers to the vehicle outside rule 34 updated by the vehicle outside transfer determination unit 24, and stores the corresponding first communication frame in the second communication frame (transfer frame). Finally, in step 124, the transfer frame generation unit 26 starts the transmission of the generated transfer frame. At this time, the transfer frame generation unit 26 can also generate the first communication frame received within a predetermined time as the transfer frame.

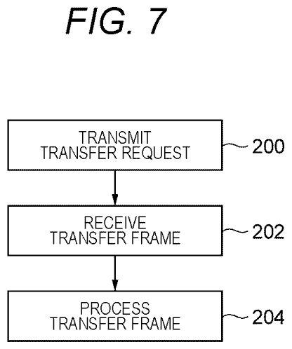

FIG. 7 is a flowchart illustrating processing performed by the T-ECU 200 in parallel with the processing by the communication device 100 described in FIG. 6.

First, in step 200, a transfer request unit 50 of the T-ECU 200 transmits a transfer request including the change instruction frame in FIG. 4 to the communication device 100. For example, the change instruction frame may be received from a server connected through a network, or may be manually input by a tool.

By transmitting the transfer request in step 200, the communication device 100 performs the processing described in FIG. 6 and generates the transfer frame. In step 202, the transmission and reception unit 40 of the T-ECU 200 receives the transfer frame from the communication device 100.

In step 204, a frame processing unit 60 of the T-ECU 200 processes the received transfer frame. For example, this is performed by restoring the plurality of first communication frames included in the data field of the transfer frame using a known method. The frame processing unit 60 can also generate a new second communication frame storing data of a plurality of first communication frames received from the external server or the like, and transmit the new second communication frame to the communication device 100 again.

As described above, in the first embodiment, the data transfer is performed while updating the vehicle outside rule is being updated in real time based on the vehicle outside rule that defines the transfer that does not directly affect the in-vehicle control, so that the appropriate data transmission and reception can be performed even while the vehicle is traveling.

### Second Embodiment

An in-vehicle communication device 100 according to a second embodiment will be described below. The communication device 100 according to the second embodiment is obtained by adding a RAM 70 of a volatile storage medium and a vehicle state determination unit 80 to the configuration of the communication device 100 according to the first embodiment. Hereinafter, only configurations and operations different from those of the first embodiment will be described, and descriptions of the same configurations and operations will be omitted.

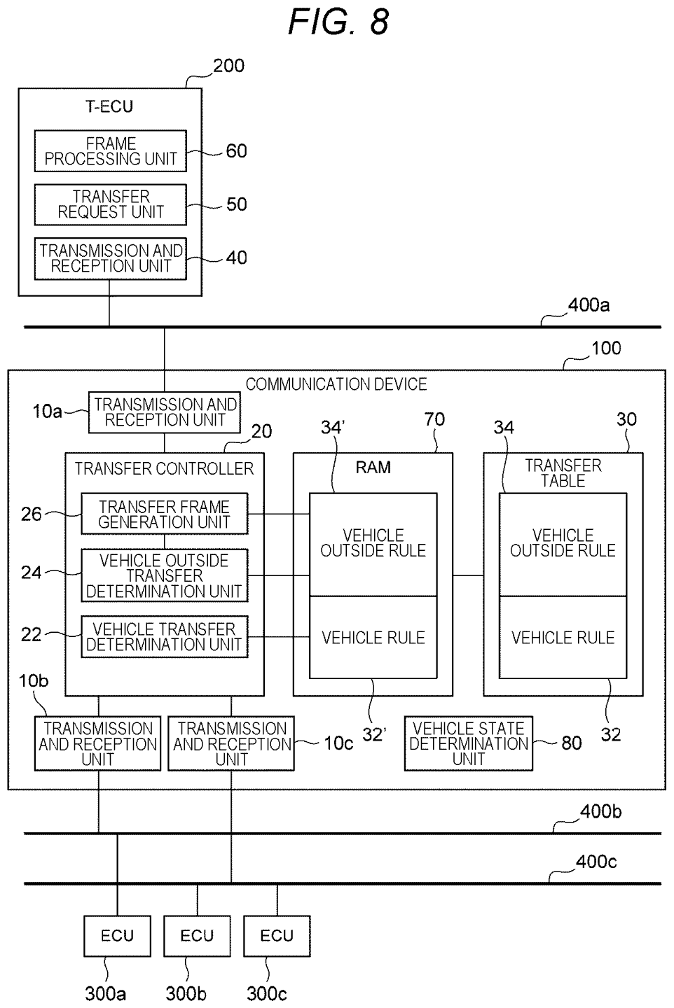

FIG. 8 is a functional block diagram illustrating a configuration of the in-vehicle communication device 100 according to the second embodiment. As described above, the communication device 100 according to the second embodiment further includes the RAM 70 and the vehicle state determination unit 80. A known RAM such as a dynamic random access memory (DRAM) or a static random access memory (SRAM) can be arbitrarily adopted as the RAM 70. The vehicle state determination unit 80 is implemented by the CPU in the communication device 100 similarly to other functional units.

The vehicle state determination unit 80 monitors whether the system of the vehicle is in a system stop state or a system activation state. The system stop state of the vehicle in the second embodiment refers to the state where an ignition is in an off state, an engine rotation speed of the vehicle is 0, or the communication device 100 is not received the communication for a certain period of time or longer. Any one or all of them may be used for the determination condition of the state of the vehicle system. The system activation state of the vehicle indicates that the ignition is on, the engine rotation speed of the vehicle is not 0, or the communication device 100 receives some communication.

When the vehicle state determination unit 80 determines that the vehicle system is in the activation state, the transfer table 30 develops the vehicle rule 32 and the vehicle outside rule 34 in the RAM 70. The vehicle rule and the vehicle outside rule that are developed in the RAM 70 are a vehicle rule 32′ and a vehicle outside rule 34′, respectively. The vehicle transfer determination unit 22 sets the vehicle rule 32′ as a reference target, and the vehicle outside transfer determination unit 24 and the transfer frame generation unit 26 set the vehicle outside rule 34′ as a reference and update target.

In the case where a difference exists between the vehicle outside rule 34′ of the RAM 70 and the vehicle outside rule 34 of the transfer table when the vehicle state determination unit 80 determines that the system of the vehicle is in the stop state, the vehicle outside transfer determination unit 24 may partially update the vehicle outside rule 34 in order to reflect the vehicle outside rule 34′. The presence or absence of the update operation may be uniquely determined at the design stage, or the presence or absence of the update operation may be made variable by adding update necessity information to the change instruction frame from the server.

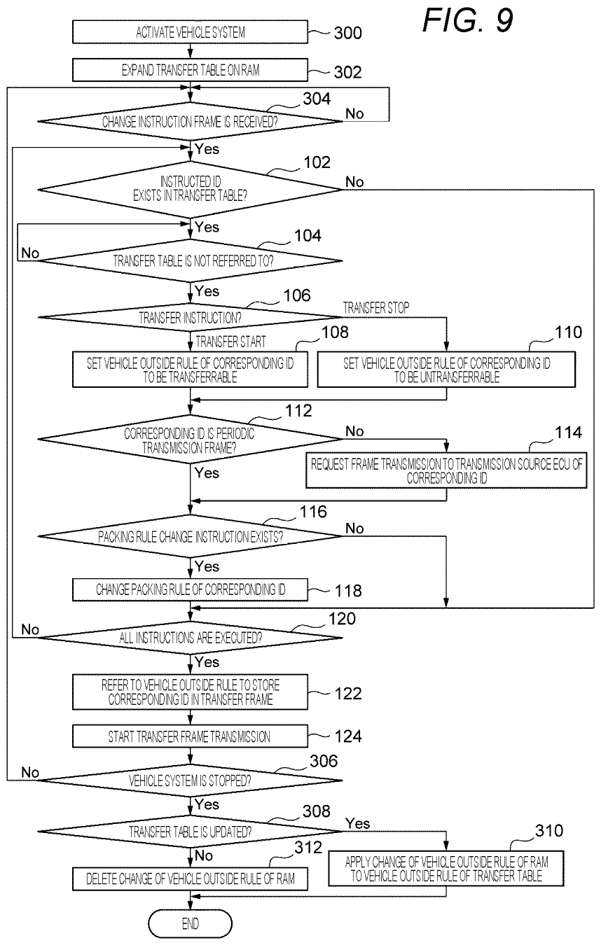

FIG. 9 is a flowchart illustrating processing executed by the in-vehicle communication device 100 according to the second embodiment. Also in FIG. 9, the same processing as the processing performed in the first embodiment described in FIG. 6 are denoted by the same reference numerals, and the description thereof is omitted.

In step 300, when the vehicle state determination unit 80 determines that the vehicle system is in the activation state, a processing sequence is started.

In step 302, the vehicle rule 32 and the vehicle outside rule 34 are developed in the RAM 70 from the transfer table 30. For example, this processing may be performed at the same time as the vehicle state determination unit 80 determines that the vehicle system is in the activation state. Subsequently, in step 304, it is checked whether the transmission and reception unit 10a receives the change instruction frame from the T-ECU 200. Thereafter, the same processing as in the first embodiment is performed until step 124 of transmitting the transfer frame.

After step 124, in step 306, the vehicle state determination unit 80 checks whether the vehicle system is in the stop state. The processing proceeds to step 308 when the vehicle system is in the stop state, and the processing proceeds to step 304 when the vehicle in the activation state.

In step 308, the vehicle outside rule 34′ of the RAM 70 is compared with the vehicle outside rule 34 of the transfer table 30, and when the difference exists between the vehicle outside rule 34′ and the vehicle outside rule 34, the vehicle outside transfer determination unit 24 determines whether the vehicle outside rule 34 of the transfer table 30 is required to be updated. For example, this determination can be made based on whether the changed rule temporarily handles data. The processing proceeds to step 310 in the case where the vehicle outside rule 34 is required to be updated, and the processing proceeds to step 312 in the case where the vehicle outside rule is not required to be updated.

In step 310, the vehicle outside transfer determination unit 24 applies the changed portion of the vehicle outside rule 34′ to the vehicle outside rule 34 of the transfer table to perform the partial update. In step 312, the vehicle outside transfer determination unit 24 does not update the vehicle outside rule 34 of the transfer table 30 but deletes the change of the vehicle outside rule 34′ of the RAM 70.

According to the second embodiment, because the transfer table temporarily developed in the RAM 70 that is the volatile storage medium is used, for example, the transfer table can be changed only during one travel, and can be easily returned to the original transfer table after the end of travel. In addition, in the case where the vehicle outside rule is changed, whether to apply or erase the change to the original vehicle outside rule 34 after the stop of the vehicle system can be selected. For example, even in the case where the change to the vehicle outside rule 34′ of the RAM 70 has a safety problem, roll back to the original safe state can be easily performed by applying the original vehicle outside rule 34.

According to the embodiments of the present invention described above, the following operational effects are obtained.
(1) An in-vehicle communication device according to an embodiment of the present invention is an in-vehicle communication device connected to a first network that performs communication using a first frame generated according to a first communication protocol and a second network that performs communication using a second frame generated according to a second communication protocol, the in-vehicle communication device includes a transmission and reception unit that transmits and receives the first frame and the second frame, in which, when receiving a transfer request of a plurality of first frames from the second network, the transmission and reception unit transmits the second frame storing the plurality of first frames to the second network in response to the transfer request.

With the above configuration, the data can be transferred without stopping the vehicle when an instruction to change the transfer data is received from a server while the vehicle is traveling.
(2) The in-vehicle communication device includes a transfer frame generation unit that stores a plurality of first frames in a second frame and generates a transfer frame. This makes it possible to suitably implement the present invention.
(3) The transfer frame generation unit generates a transfer frame storing a plurality of first frames received within a predetermined time. Thus, for example, by setting the cycle of a specific frame as a predetermined time, the frame is also periodically transferred, which is advantageous in terms of data management.
(4) The in-vehicle communication device further includes: a transfer table storage unit that stores transfer table in which transfer rules of the first frame and the second frame are described; and a transfer determination unit that, when receiving a transfer request of a plurality of first frames from the second network, determines whether to transfer the first frame requested to be transferred and controls the transfer table, in which the transfer frame generation unit refers to the transfer table and generates the transfer frame storing the plurality of first frames determined to be transferable by the transfer determination unit. Thus, a risk of causing some trouble can be eliminated by transferring a frame that should not be transferred when a criterion for determining that the frame can be previously transferred is set.
(5) The transfer determination unit permits transfer of the first frame when the first frame requested to be transferred does not include data related to internal control of a vehicle on which the in-vehicle communication device is mounted. Thus, the risk of transferring the data related to the internal control of the vehicle and causing a problem in the function of the vehicle can be eliminated.
(6) When the first frame requested in the transfer request is not a frame that is periodically transmitted, the transfer determination unit requests a communication device that is a transmission source of the requested first frame to transmit the requested first frame. Thus, the data is not missed even for an ECU that does not voluntarily transmit the data, such as an ECU related to diagnosis.
(7) Control of the transfer table by the transfer determination unit and reference to the transfer table by the transfer frame generation unit are exclusively controlled. Thus, generation of malfunction due to overlapping of accesses to the transfer table can be prevented.
(8) The second frame in the second communication protocol includes a data portion larger than a data portion of the first frame. This makes it possible to store a plurality of first frames in the second frame.
(9) The in-vehicle communication device further includes a volatile storage medium capable of developing a content of the transfer table stored in the transfer table storage unit, in which the transfer frame generation unit and the transfer determination unit can refer to the transfer table developed in the volatile storage medium. Thus, for example, the transfer table can be changed only during one travel, and easily returned to the original transfer table after the travel is finished.
(10) The in-vehicle communication device further includes a vehicle state determination unit that determines a current operation state of a vehicle on which the in-vehicle communication device is mounted, in which, when the vehicle is in an operation stop state and when a transfer table developed in the volatile storage medium is changed, the vehicle state determination unit reflects the change in the transfer table stored in the transfer table storage unit. Thus, for example, even in the case where the change to the vehicle outside rule of the RAM has a problem in safety, the roll back to the original safe state can be easily performed by applying the original vehicle outside rule.
(11) An in-vehicle network system according to another embodiment of the present invention is an in-vehicle network system includes: the in-vehicle communication device; and a second communication device connected to the in-vehicle communication device through the second network, in which the second communication device includes: a transmission and reception unit of the second frame; a transfer request unit that transmits a transfer request storing a plurality of first frames in the second frame and transferring the second frame to the in-vehicle communication device; and a frame processing unit that extracts information about stored the plurality of first frames from the second frame storing the plurality of first frames. Thus, the in-vehicle communication device according to the present invention can be suitably applied to such the in-vehicle network.
(12) The frame processing unit generates a second frame storing a plurality of first frames transmitted to the first network through the in-vehicle communication device. The plurality of first frames received from the external server or the like can be transmitted to the in-vehicle communication device side by one communication.

The present invention is not limited to the above-described embodiments, but includes various modifications. For example, the above-described embodiments have been described in detail for easy understanding of the present invention, and are not necessarily limited to those having all the described configurations. In addition, a part of the configuration of a certain embodiment can be replaced with the configuration of another embodiment, and a part of the configuration of another embodiment can be added to the configuration of a certain embodiment. In addition, it is possible to use, delete, and replace other configurations for a part of the configuration of each embodiment. In addition, some or all of the above-described configurations, functions, processing units, processing means, and the like may be implemented by hardware, for example, by designing with an integrated circuit. In addition, each of the above-described configurations, functions, and the like may be implemented by software in which a processor implements each function. Information such as a program, a table, and a file for implementing each function can be stored in a recording device such as a memory, a hard disk, or a solid state drive (SSD), a recording medium such as an IC card, an SD card, or a DVD, or various recording media mounted in a microcomputer.

### REFERENCE SIGNS LIST

10a to 10c, 40 transmission and reception unit
22 vehicle transfer determination unit
24 vehicle outside transfer determination unit
26 transfer frame generation unit
30 transfer table
50 transfer request unit
60 frame processing unit
70 RAM (volatile storage medium)
80 vehicle state determination unit
100 in-vehicle communication device
200 T-ECU (second communication device)

1. An in-vehicle communication device connected to a first network that performs communication using a first frame generated according to a first communication protocol and a second network that performs communication using a second frame generated according to a second communication protocol, the in-vehicle communication device comprising a transmission and reception unit that transmits and receives the first frame and the second frame,
wherein, when receiving a transfer request of a plurality of first frames from the second network, the transmission and reception unit transmits the second frame storing the plurality of first frames to the second network in response to the transfer request.

2. The in-vehicle communication device according to claim 1, comprising a transfer frame generation unit that stores the plurality of first frames in the second frame and generates a transfer frame.

3. The in-vehicle communication device according to claim 2, wherein the transfer frame generation unit generates the transfer frame storing the plurality of first frames received within a predetermined time.

4. The in-vehicle communication device according to claim 2, further comprising:
a transfer table storage unit that stores a transfer table in which transfer rules of the first frame and the second frame are described; and
a transfer determination unit that, when receiving a transfer request of the plurality of first frames from the second network, determines whether to transfer the first frame requested to be transferred and controls the transfer table,
wherein the transfer frame generation unit refers to the transfer table and generates the transfer frame storing the plurality of first frames determined to be transferable by the transfer determination unit.

5. The in-vehicle communication device according to claim 4, wherein the transfer determination unit permits transfer of the first frame when the first frame requested to be transferred does not include data related to internal control of a vehicle on which the in-vehicle communication device is mounted.

6. The in-vehicle communication device according to claim 4, wherein, when the first frame requested in the transfer request is not a frame that is periodically transmitted, the transfer determination unit requests a communication device that is a transmission source of the requested first frame to transmit the requested first frame.

7. The in-vehicle communication device according to claim 4, wherein control of the transfer table by the transfer determination unit and reference to the transfer table by the transfer frame generation unit are exclusively controlled.

8. The in-vehicle communication device according to claim 1, wherein the second frame in the second communication protocol includes a data portion larger than a data portion of the first frame.

9. The in-vehicle communication device according to claim 4, further comprising a volatile storage medium capable of developing a content of the transfer table stored in the transfer table storage unit,
wherein the transfer frame generation unit and the transfer determination unit can refer to the transfer table developed in the volatile storage medium.

10. The in-vehicle communication device according to claim 9, further comprising a vehicle state determination unit that determines a current operation state of a vehicle on which the in-vehicle communication device is mounted,
wherein, when the vehicle is in an operation stop state and when a transfer table developed in the volatile storage medium is changed, the vehicle state determination unit reflects the change in the transfer table stored in the transfer table storage unit.

11. An in-vehicle network system comprising:
the in-vehicle communication device according to claim 1; and
a second communication device connected to the in-vehicle communication device through the second network,
wherein the second communication device includes:
a transmission and reception unit of the second frame;
a transfer request unit that transmits a transfer request storing the plurality of first frames in the second frame and transferring the second frame to the in-vehicle communication device; and
a frame processing unit that extracts information about stored the plurality of first frames from the second frame storing the plurality of first frames.

12. The in-vehicle network system according to claim 11, wherein the frame processing unit generates a second frame storing the plurality of first frames transmitted to the first network through the in-vehicle communication device.
